(19) United States
(12) Patent Application Publication
(10) Pub. No.: US 2007/0291191 A1
(43) Pub. Date: Dec. 20, 2007

(54) LIQUID CRYSTAL DISPLAY PANEL

(76) Inventor: Wen-Hsiung Liu, Pingtung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,077

(22) Filed: Jun. 16, 2006

(51) Int. Cl. G02F 1/1343

(52) U.S. Cl. 349/38

(57) ABSTRACT

A liquid crystal display panel having scan lines, data lines and pixel units is provided. The scan lines and the data lines crisscross each other on a substrate. Each pixel unit is electrically connected to one of the scan lines and one of the data lines. Each pixel unit includes an active device, a liquid crystal capacitor and a storage capacitor. The active device is disposed on the substrate. The liquid crystal capacitor is electrically connected to the active device. The storage capacitor is electrically connected to the liquid crystal capacitor. The capacitances of the storage capacitors decrease inward from the two sides of the liquid crystal display panel. The capacitance is varied in such a way that the voltage difference of the liquid crystal in the positive and the negative frame at the same brightness level is equalized to prevent the liquid crystal display panel from flickering.

### BACKGROUND OF THE INVENTION

1. Field of the Invention

The present invention relates to a liquid crystal display panel. More particularly, the present invention relates to a liquid crystal display panel having a design capable of preventing image flickering.

2. Description of the Related Art

Due to the handiness of controlling equipment with information read from a display device, it has become an important means of communication between human and machine. In particular, the development of liquid crystal display is fast and important. In general, a liquid crystal display comprises a back light module and a liquid crystal display panel. The liquid crystal display panel includes an array of pixel units with each pixel unit comprising at least a scan line, a data line, a thin film transistor (TFT), a liquid crystal capacitor and a storage capacitor. The TFT is used as a switching element for the pixel unit. The scan line and the data line are used for providing a suitable operating voltage to a selected pixel unit so that the pixel units are individually driven to display an image. In addition, the liquid crystal capacitor is composed of a pixel electrode, a common electrode and a liquid crystal layer disposed between the two electrodes. Furthermore, when voltages are applied to the pixel electrode and the common electrode respectively, the liquid crystal molecules within the liquid crystal layer will be re-aligned according to the direction and magnitude of the electric field between the common electrode and the pixel electrode. Therefore, the light passing through the liquid crystal display panel has different levels of brightness. The storage capacitor provides the voltage needed for maintaining the tilt orientation of the liquid crystal molecules while the voltage applied on the pixel electrode is shut down.

In the process of driving the liquid crystal display panel, if the liquid crystal molecules are kept in one configuration by a fixed electric field for a long time, their properties may deteriorate. As a result, the liquid crystal molecules can no longer rotate in response to the change in the electric field. Therefore, the magnitude of the electric field where the liquid crystal molecules are located must be changed once after a period of time. However, if a particular pixel unit needs to be in the same level for an extended period of time, the positive and negative polarity can be alternately changed. Hence, the electric field can change direction without ever changing the magnitude of the electric field so that any damaging effect on the properties of the liquid crystal molecules is minimized. Yet, driving the liquid crystal display in this way often leads to image flickering problem. The reason for the flickering in the liquid crystal display is explained more fully in the following description.

FIG. 1 is a time sequence diagram showing the waveform for driving a pixel unit of a conventional liquid crystal display panel. As shown in FIG. 1, the horizontal axis represents the frame and the vertical axis represents voltage value. The curve C1 indicates the voltage signal in the scan line, the curve C2 indicates the voltage signal in the data line, the curve C3 indicates the voltage signal on the pixel electrode, the curve C4 indicates the voltage value of the common electrode on the color filter substrate. At frame t1, the voltage signal on the pixel electrode has a positive polarity and the voltage difference between the pixel electrode and the common electrode is Vlc1. At frame t2, the voltage signal on the pixel electrode has a negative polarity and the voltage difference between the pixel electrode and the common electrode is Vlc2. If the level that needs to be displayed at frame t1 and at frame t2 is identical, the absolute value of the voltage difference VIc1 and the voltage difference Vlc2 must be equal.

However, a parasitic capacitance exists between the gate and the drain of the TFT. This parasitic capacitance will produce a voltage variation quantity, the so-called feed-through voltage ΔVp, in the voltage curve C3 of the pixel electrode according to the signal variation in the data line. The feed-through voltage ΔVp will cause the absolute value of the voltage difference Vlc1 and the voltage difference Vlc2 to differ and lead to the image flickering problem in the liquid crystal display panel. At present, the most commonly adopted method of resolving the flickering problem is to adjust the common voltage (that is, the curve C4) so that the absolute value of the voltage difference Vlc1 and Vlc2 become identical.

If the feed-through voltage ΔVp of each pixel is identical, the flickering problem in the liquid crystal display is definitely resolved through an adjustment of the common voltage (the curve C4). However, due to actual processing or other factors, the feed-through voltage ΔVp of each pixel unit in the liquid crystal display panel may be different. Furthermore, the resistance and the capacitance of the liquid crystal display panel cause the resistance-capacitance (RC) delay and then resulting in signal distortion on the scan line. In other words, the feed-through voltage ΔVp at the front end and the back end of the same scan line may not be the same. Under such circumstances, it is impossible to render the voltage difference between the pixel electrode and the common electrode (the difference in between the curves C3 and C4) in the pixels controlled by the front end of the scan line and the pixels controlled by the back end of the same scan line identical by adjusting the curve C4. Hence, the image flickering problem remains unsolved.

Furthermore, the difference in the charging/discharging capacity of each pixel electrode in the liquid crystal display panel is also a factor that contributes to the image flickering problem.

### SUMMARY OF THE INVENTION

Accordingly, at least one objective of the present invention is to provide a liquid crystal display panel capable of resolving mura problem and image-flickering problem.

To achieve these and other advantages and in accordance with the purpose of the invention, as embodied and broadly described herein, the invention provides a liquid crystal display panel. The liquid crystal display panel comprises a plurality of scan lines, a plurality of data lines and a plurality of pixel units. The scan lines and the data lines crisscross each other on a substrate. Each pixel unit is electrically connected to one scan line and one data line. Each pixel unit includes an active device, a liquid crystal capacitor and a storage capacitor. The active device is disposed on the substrate. The liquid crystal capacitor is electrically connected to the active device. The storage capacitor is electrically connected to the liquid crystal capacitor. The capacitance of the storage capacitor decreases inward from the two sides of the liquid crystal display panel.

In one embodiment of the present invention, the capacitance of the storage capacitor randomly decreases from both sides to the inner.

In one embodiment of the present invention, the aforementioned storage capacitor comprises one pixel electrode, an electrode layer and a dielectric layer. The electrode layer is disposed under the pixel electrode and the dielectric layer is disposed between the pixel electrode and the electrode layer. The area of the pixel electrodes decreases inward from the two sides of the liquid crystal display panel, for example. Further example, the area of the pixel electrodes randomly decrease inward from the two sides of the liquid crystal display panel. In addition, each the liquid crystal capacitor includes pixel electrode, common electrode and liquid crystal layer. The pixel electrode is connected to the active device. The liquid crystal layer is located between the pixel electrode and the common electrode. The capacitance of the liquid crystal capacitor is, for example, decreasing inward from the two sides. Further for example, the capacitance of the liquid crystal capacitor is randomly decreasing inward from the two sides. Furthermore, the electrode layer can be a common line or the scan line. In another embodiment, the area of the common lines decreases inward from the two sides of the liquid crystal display panel, for example. The area of the common lines, for example, randomly decreases inward from the two sides of the liquid crystal display panel.

In one embodiment of the present invention, the aforementioned active device is a thin film transistor.

The liquid crystal display panel in the present invention utilizes the variation of area of the pixel electrode or the common line to adjust the capacitance of the storage capacitor. Therefore, whether in the positive frame or in the negative frame, the absolute value of the voltage difference at the pixel electrode and the common electrode are identical in each pixel unit. As a result, the amount of flickering in the liquid crystal display is significantly reduced.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a time sequence diagram showing the waveform for driving a pixel unit of a conventional liquid crystal display panel.

FIG. 2 is a circuit diagram of a liquid crystal display panel according to one embodiment of the present invention.

FIG. 3A is a top view showing part of the liquid crystal display panel as shown in FIG. 2.

FIG. 3B is a schematic cross-sectional view along line I-I of FIG. 3A.

FIG. 4 is a complete top view of the liquid crystal display panel shown in FIG. 2.

FIG. 5 is a graph with curves showing the voltage different between the pixel electrode and the common electrode when the pixel electrode between the observing points in the liquid crystal display panel shown in FIG. 4 are driven by positive voltage and negative voltage respectively.

FIG. 6 is a graph with curves showing the ideal common voltage Vcom1 and the actual common voltage Vcom2 of the liquid crystal display panel shown in FIG. 4.

FIG. 7 is a graph showing the variation of the capacitance Cs of the storage capacitor according to the present invention in a liquid crystal display panel.

FIG. 8 is a top view showing part of a liquid crystal display panel according to one embodiment of the present invention.

FIG. 9 is a top view showing part of a liquid crystal display panel according to another embodiment of the present invention.

FIG. 10 is a top view showing part of a liquid crystal display panel according to yet another embodiment of the present invention.

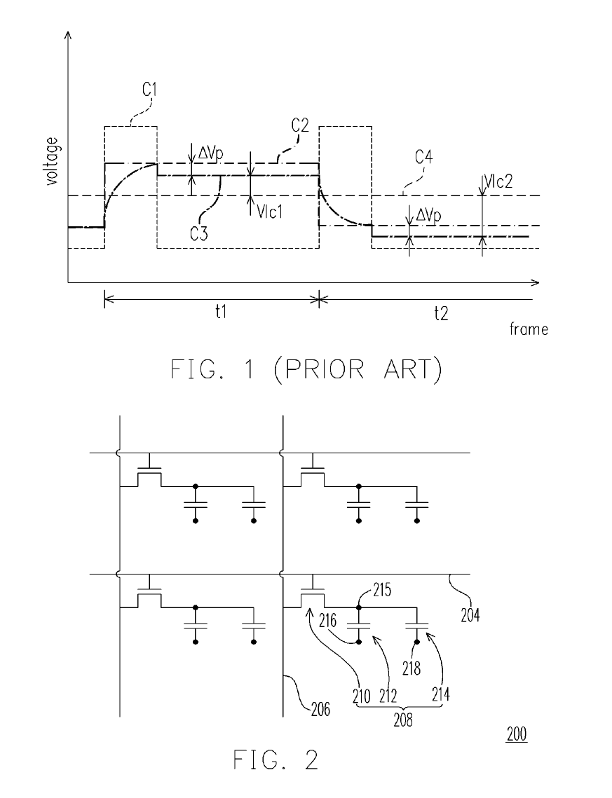

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

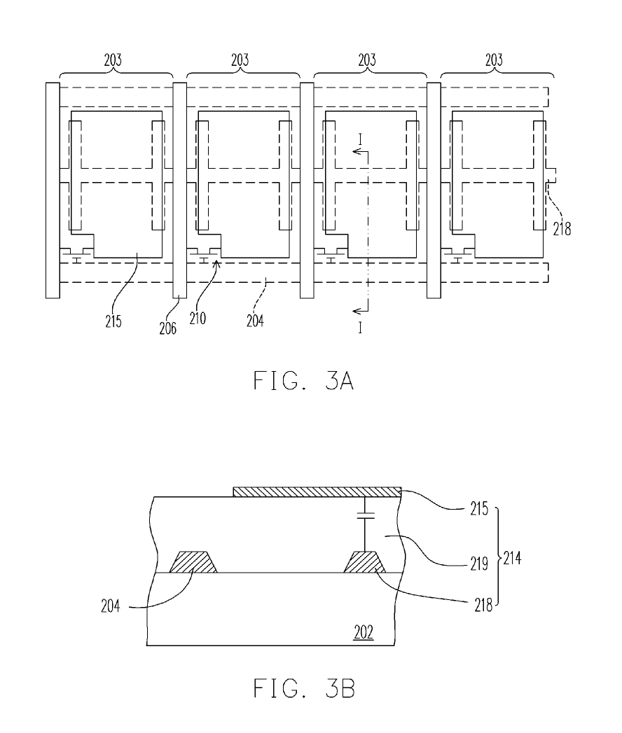

FIG. 2 is a circuit diagram of one type of a liquid crystal display panel. FIG. 3A is a top view showing part of the liquid crystal display panel as shown in FIG. 2. FIG. 3B is a schematic cross-sectional view along line I-I of FIG. 3A. As shown in FIGS. 2, 3A and 3B, the liquid crystal display panel 200 includes a substrate 202, a plurality of scan lines 204, a plurality of data lines 206 and a plurality of pixel units 208. The scan lines 204 and the data lines 206 are disposed on the substrate 202 and crisscrossing each other to define a plurality of pixel regions 203 on the substrate 202. Each pixel unit 208 is disposed inside a pixel region 203 and electrically connected to corresponding scan line 204 and data line 206. Each pixel unit 208 includes an active device 210, a liquid crystal capacitor 212 and a storage capacitor 214. The active device 210 is a thin film transistor, for example.

Those skilled in the art should understand that the liquid crystal capacitor 212 is composed of a pixel electrode 215, a common electrode 216 and a liquid crystal layer (not shown) between the two electrodes. The pixel electrode 215 is electrically connected to the drain of the active device 210 and the common electrode 216 is formed on a color filter (not shown). As the name implies, the common electrode 216 is shared among all the pixel units 208. When voltages are applied to the pixel electrode 215 and the common electrode 216 respectively, the liquid crystal molecules within each pixel region 203 will tilt and rotate according to the direction and magnitude of the electric field produced by the voltage difference between the pixel electrode and the common electrode. As a result, light passing through the liquid crystal display panel 200 will display needed levels of brightness.

As shown in FIGS. 3A and 3B, the storage capacitor 214 is electrically connected to the liquid crystal capacitor 212. The storage capacitor 214 in the present embodiment is composed of a pixel electrode 215, a common line 218 and a dielectric layer 219 between the two electrodes. The storage capacitor 214 serves to provide the voltage needed to maintain the tilt orientation of the liquid crystal molecules while the voltage applied on the pixel electrode is shut down. In general, the common line 218 and the scan line 204 are formed simultaneously. In other words, the common line 218 and the scan line 204 are the same layer. In FIG. 3A, the common line and the scan line 204 are represented using dash lines.

The storage capacitor 214 in the present embodiment includes the common line 218 (that is, the so-called Cs-on-common). However, in another embodiment, the storage capacitor in the present invention can be composed of the scan line 204 (that is, the so-called Cs-on-gate). In the present invention, there is no particular limitation on the configuration of the storage capacitor.

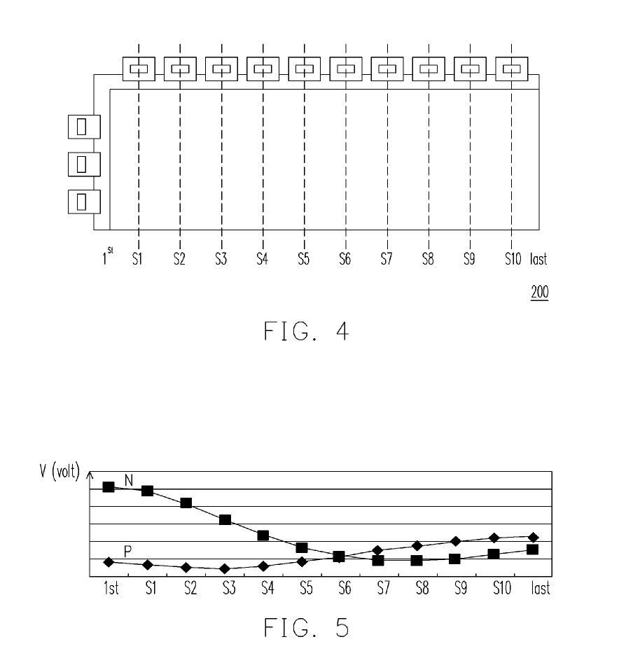

FIG. 4 is a complete top view of the liquid crystal display panel shown in FIG. 2. As shown in FIG. 4, the liquid crystal display panel 200 in the present embodiment is divided into eleven observing points through 1^{st}, S1˜S10 and last for the ease of explanation. The pixel units 208 are disposed between the observing point 1^{st} and the observing point last.

FIG. 5 is a graph with curves showing the voltage different between the pixel electrode and the common electrode when the pixel electrode between the observing points in the liquid crystal display panel shown in FIG. 4 are driven by positive voltage and negative voltage respectively. If the voltage of the common electrode 216 in one of the 1^{st} last observing point (for example, the observing point S6) is targeted to be adjusted, the voltage difference between the pixel electrode 215 and the common electrode 216 are equalized when the pixel electrode 215 of this observing point is driven by positive voltage and negative voltage so that flickering problem in the observing point can be prevented with the result as shown in FIG. 5. The curve N represents the voltage difference between the pixel electrode 215 and the common electrode 216 in each observing point when the pixel electrode 215 is driven using negative voltage. On the contrary, the curve P represents the voltage difference between the pixel electrode 215 and the common electrode 216 in each observing point when the pixel electrode 215 is driven using a positive voltage. As shown in FIG. 5, although the liquid crystal display panel 200 does not have flickering problem at the observing point S6, some difference in the voltage value between the curve P and the curve N still persists in other observing points. In other words, aside from the observing point S6, the voltage differences between the pixel electrodes 215 driven by a positive voltage and the common electrodes 216 are still not equal to the voltage differences between the pixel electrodes 215 driven by a negative voltage and the common electrodes 216 between the observing points.

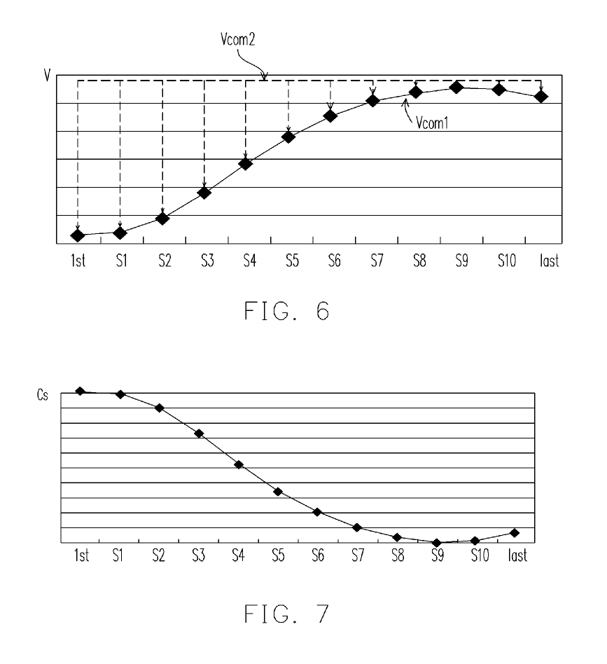

FIG. 6 is a graph with curves showing the ideal common voltage Vcom1 and the actual common voltage Vcom2 of the liquid crystal display panel shown in FIG. 4. As shown in FIG. 6, the curve Vcom1 is the voltage curve that needs to be applied to the common electrode 216 if the voltage differences between the pixel electrodes driven by a positive voltage and the common electrode is required to equal to the voltage differences between the pixel electrodes 215 driven by a negative voltage and the common electrodes between the 1^{st} ˜last observing points. It should be noted that the common electrode 216 is the electrode for all the observing points in the liquid crystal display panel. Therefore, it is impossible to produce different common voltage value at different observing points. In other words, the voltage curve Vcom1 is impossible to be implemented. Accordingly, the common electrode is actually driven by using the voltage curve Vcom2 in the present invention. In the following, using the voltage curve Vcom2 to drive the common electrode can produce an effect identical to using the ideal voltage curve Vcom1 is explained in more detail.

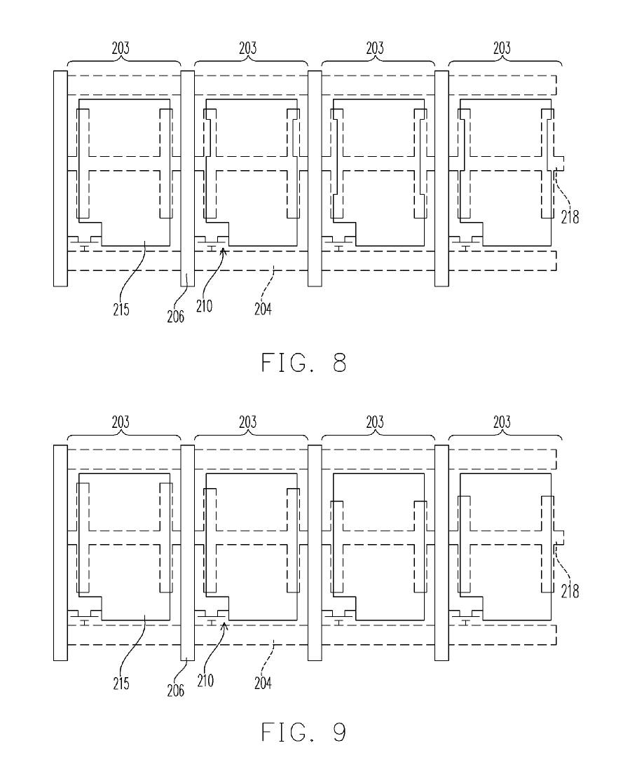

FIG. 7 is a graph showing the variation of the capacitance Cs of the storage capacitor 214 according to the present invention in the liquid crystal display panel 200. As shown in FIG. 7, the capacitance Cs decreases inward from the two sides of the liquid crystal display panel 200. In the following, an example showing the method for implementing the distribution of the capacitance Cs shown in FIG. 7 is provided.

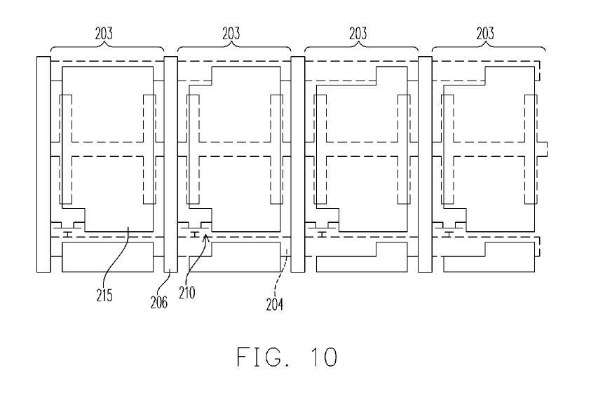

FIG. 8 is a top view showing part of a liquid crystal display panel according to one embodiment of the present invention. As shown in FIG. 8, an electrode of the storage capacitor 214 in the present embodiment is the pixel electrode 215 and another electrode is the common electrode 218. Moreover, to match the distribution of the capacitance Cs of the storage capacitor 214 in the liquid crystal display panel 200 with the curve in FIG. 7, the overlapping area between the pixel electrode 215 and the common line 218 decreases inward from the two sides of the liquid crystal display panel 200, for example. Two arrangements can be made to match the distribution of the capacitance Cs of the storage capacitor 214 with the curve in FIG. 7. The area of the pixel electrode 215 can decrease inward (as shown in FIG. 8) from the two sides of the liquid crystal display panel 200 or the area of the common line 218 decreases inward (as shown in FIG. 9) from the two sides of the liquid crystal display panel 200.

It should be noted that adjusting the area of the pixel electrode 215 of the liquid crystal display panel 200 shown in FIG. 8 would change the capacitance of the liquid crystal capacitor 212 (see FIG. 2) also. In other words, the capacitance of the liquid crystal capacitor 212 will have a distribution closely resembling the capacitance Cs of the storage capacitor 214. Now, the capacitance of the liquid crystal capacitor 212 is one of the parameters of the feed-through voltage. Therefore, the simultaneous inward reduction of the capacitance of the liquid crystal capacitor 212 and the storage capacitor 214 from the sides of the liquid crystal display panel 200 can minimize the flickering of the liquid crystal panel 200 even further.

The storage capacitor 214 in the foregoing embodiment is composed of the common line 218 (the so-called Cs-on-common). However, in other embodiments, the storage capacitor also can be composed of the scan line (the so-called Cs-on-gate). FIG. 10 is a top view showing part of a liquid crystal display panel according to yet another embodiment of the present invention. As shown in FIG. 10, an electrode of the storage capacitor 214 in the present embodiment is the pixel electrode 215 and the other electrode is the scan line 204. Furthermore, the area of the pixel electrode 215 in the present embodiment may also decrease inward from the two sides of the liquid crystal display panel 200 so that the distribution of the capacitance Cs of the storage capacitor 214 can match the curve in FIG. 7.

In the following, the method of arranging the area of the pixel electrode 215 or the common line 218 is further explained using an embodiment. In the embodiment, the storage capacitor 214 has the capacitance Cs, which is, for example, randomly decreasing inward from the two sides of the liquid crystal display panel 200. In other words, the capacitance Cs of the storage capacitor 214 in the liquid crystal display panel 200 is not a linear distribution. Further, the method for implement this arrangement is, for example, randomly decreasing the area of the pixel electrode 215 inward from two sides of the liquid crystal display panel 200. Alternatively, for example, the area of the common line 218 randomly decreases inward from two sides of the liquid crystal display panel 200. In the embodiment, the 1^{st} and the last of the observing points are used as the boundary, and the liquid crystal display panel 200 is divided into several regions. Each region includes a portion of the pixel unit 208. For example in the embodiment, a region is between the observing point 1^{st} and the observing point S1.

As shown in FIGS. 4 and 7, there are X+Y pixel units between the observing point 1^{st} and the observing point S1, for example. Furthermore, inside the area between the observing point 1^{st} and the observing point S1, the area of the storage capacitor must decrease by 2X+Y μm². Hence, the voltage differences between the pixel electrodes driven by positive voltage and the common electrode and the voltage differences between the pixel electrodes driven by negative voltage and the common electrode are equal to prevent image flickering. In other words, between the observing point 1^{st} and the observing point S1, X pixel units belong to a first group and the remaining Y pixel units belong to a second group. For the pixel units belonging to the first group, the area of the storage capacitor decreases by 2 μm² after each alternate pixel unit. For the pixel units belonging to the second group, the area of the storage capacitor decreases by 1 μm² after each alternate pixel unit.

It should be noted that the first group and the second group of pixel units in the area between the observing point 1^{st} and the observing point S1 are randomly distributed. In other words, in the area between the observing point 1^{st} and the observing point S1, the pixel units in the same group need not to be aligned together. Rather, the pixel units are randomly distributed so that the distribution of the capacitance in the liquid crystal display panel in the present invention is as close to the ideal curve shown in FIG. 7 as possible. Hence, the mura problem shown on the liquid crystal display panel between the observing point 1^{st} and the observing point S1 can be avoided. Obviously, the same principle of area adjustment of the pixel electrode or the common line can similarly be applied to other areas of the liquid crystal display panel 200.

On the other hand, The area of the pixel electrode 215 is adjusted, so as to have the capacitance Cs of the storage capacitor 214 to be randomly decreasing inward from two sides of the liquid crystal display panel 200. Since the adjustment on the area of the pixel electrode 215 also simultaneously changes the capacitance of the liquid crystal capacitor 212 (see FIG. 2), the capacitance of the liquid crystal capacitor 212 is also randomly decreasing inward from two sides of the liquid crystal display panel 200.

In summary, the liquid crystal display panel uses the area variation in the pixel electrode or the common line to adjust the capacitance of the storage capacitors and the liquid crystal capacitors. Hence, the absolute voltage difference value of the pixel electrode and the common electrode are equal when the pixel electrode is driven by the identical positive voltage and negative voltage and image flickering on the liquid crystal display panel is minimized. In addition, the variation of the capacitance value inside the liquid crystal display panel in the present invention is randomly distributed rather than linear so that mura problem on the liquid crystal display panel can be avoided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display panel disposed on a substrate, comprising:
a plurality of scan lines disposed on the substrate;
a plurality of data lines disposed on the substrate crisscrossing the scan lines;
a plurality of pixel units, each pixel unit electrically connected to one of the scan lines and one of the data lines, wherein each pixel unit comprises:
an active device disposed on the substrate;
a liquid crystal capacitor electrically connected to the active device; and
a storage capacitor electrically connected to the liquid crystal capacitor;
wherein a capacitance of the storage capacitors is decreased inward from the two sides of the liquid crystal display panel.

2. The liquid crystal display panel of claim 1, wherein capacitances of the storage capacitors randomly decrease inward from the two sides of the liquid crystal display panel.

3. The liquid crystal display panel of claim 1, wherein each storage capacitor further comprises:
a pixel electrode;
an electrode layer disposed under the pixel electrode; and
a dielectric layer disposed between the pixel electrode and the electrode layer.

4. The liquid crystal display panel of claim 3, wherein areas of the pixel electrodes decrease inward from the two sides of the liquid crystal display panel.

5. The liquid crystal display panel of claim 4, wherein the areas of the pixel electrodes randomly decrease inward from the two sides of the liquid crystal display panel.

6. The liquid crystal display panel of claim 4, wherein each of the liquid crystal capacitor comprises:
the pixel electrode, for electrically connecting to the active device;
a common electrode; and
a liquid crystal layer, disposed between the pixel electrode and the common electrode.

7. The liquid crystal display panel of claim 6, wherein capacitances of the liquid crystal capacitors decreases inward from the two sided of the liquid crystal display panel.

8. The liquid crystal display panel of claim 7, wherein the capacitances of the liquid crystal capacitor randomly decrease inward from the two sided of the liquid crystal display panel.

9. The liquid crystal display panel of claim 3, wherein each electrode layer is one of the common lines or the scan lines.

10. The liquid crystal display panel of claim 9, wherein areas of the common lines decrease inward from the two sides of the liquid crystal display panel.

11. The liquid crystal display panel of claim 10, wherein the areas of the common lines randomly decrease inward from the two sides of the liquid crystal display panel.

12. The liquid crystal display panel of claim 1, wherein the active device includes a thin film transistor.
